(19) United States
(12) Patent Application Publication
(10) Pub. No.: US 2007/0220704 A1
(43) Pub. Date: Sep. 27, 2007

(54) ARTICULATED CASTER WITH PIVOT BOX JOINT

(76) Inventor: Douglas G. Willis, Colby, KS (US)

Correspondence Address: HOVEY WILLIAMS LLP, 2405 GRAND BLVD., SUITE 400, KANSAS CITY, MO, 64108, US

(21) Appl. No.: 11/277,557

(22) Filed: Mar. 27, 2006

(51) Int. Cl. B60B 33/00

(52) U.S. Cl. 16/47

(57) ABSTRACT

Articulated casters (14, 16) of low-cost design are provided which include an apertured base (18) with a plurality of caster wheels (20, 22, 24) coupled with the base and pivotal about respective upright axes. An upright pivot arm (26) having a lower end (60) and an upper load-supporting end, with the lower end (60) extending through the base aperture and being pivotally connected to the base via a pivot assembly (28). The assembly (28) includes an open-top housing (64) which receives the pivot arm lower end (60), as well as a connection assembly (74) securing the housing (64), base (18), and pivot arm (26) in order to permit relative pivotal movement between the pivot arm (26) and base (18).

### BACKGROUND OF THE INVENTION

1. Field of the Invention

The present invention is broadly concerned with improved articulated casters designed to support heavy loads. The invention is particularly beneficial in facilitating traversal of the load over sloped or uneven surfaces, or when obstacles are encountered. More particularly, the invention is concerned with an articulated caster assembly having an inexpensive yet rugged pivot assembly for pivotally interconnecting an upright pivot arm and the base of a caster assembly.

2. Description of the Prior Art

Casters are well known devices that assist in the mobility of a great variety of equipment and other loads. They are used in industry, in the home, in the medical field, and in general wherever it is desirable to efficiently move objects over surfaces. While casters function well on smooth surfaces, they tend to operate less efficiently when used on uneven surfaces or when obstructions are encountered. In order to overcome this problem, articulated casters have been developed which are better adapted to maneuver over uneven surfaces and/or obstructions.

U.S. Pat. No. 5,507,069 describes a type of articulated caster of three-wheeled tricycle design. The casters of the '069 patent include a central upstanding pivot arm extending through the caster base and pivotally connected thereto. The upper end of the arm is designed to support loads. The pivot assembly described in this patent makes use of a ball joint housed within a slotted carrier. Such a pivot assembly, while useful for its intended purpose, is very costly to manufacture, requiring multiple fabrication steps.

There is accordingly a need in the art for improved articulated casters which afford a desirable degree of pivotal movement so as to traverse without difficulty uneven surfaces and the like, while at the same time having pivot coupling assemblies which are durable and inexpensive to manufacture from the standpoints of materials used and fabrication steps.

### SUMMARY OF THE INVENTION

The present invention overcomes the problems outlined above, and provides an improved articulated caster characterized by reduced manufacturing costs and high operational deficiencies. According to one aspect of the present invention, the articulated caster generally includes a caster assembly, an upright pivot arm, and a pivot assembly. The caster assembly includes a base and at least three spaced apart caster wheels that are attached to and cooperatively support the base so that the caster assembly is self-supporting. The upright pivot arm has a lower end and an upper end adapted for connection with a load. The pivot assembly operably couples the lower end of the arm with the base. The pivot assembly includes an open-top housing receiving the lower end of the pivot arm. The pivot assembly further includes a connection assembly interconnecting the housing, base, and pivot arm in order to permit relative pivotal movement between the pivot arm and base about generally transverse first and second pivot axes.

Another aspect of the present invention concerns a carriage including a load-supporting component and two or more spaced apart wheeled supports, at least one of which is an articulated caster. The articulated caster is constructed as previously described.

In preferred forms, the pivot assembly housing is substantially quadrate in plan configuration, presenting opposed sidewalls and opposed end walls. The preferred pivot arm is of mating, square tubular design and is received between the housing sidewalls. The connection assembly includes a pair of low-cost bolt and nut connectors securing the base and end walls of the housing and defining a first pivot axis. Additionally, a second coupler connects the housing sidewalls and the lower end of the pivot arm to define a second horizontal pivot axis transverse to the first pivot axis.

Other aspects and advantages of the present invention will be apparent from the following detailed description of the preferred embodiments and the accompanying drawing figures.

### BRIEF DESCRIPTION OF THE DRAWINGS

Preferred embodiments of the invention are described in detail below with reference to the attached drawing figures, wherein:

FIG. 1 is a perspective view of a load-supporting carriage incorporating articulated casters constructed in accordance with a preferred embodiment of the present invention;

FIG. 2 is a fragmentary, perspective, exploded view of the components of one of the articulated casters depicted in FIG. 1, with the articulated casters preferably being similarly constructed;

FIG. 3 is a fragmentary vertical sectional view of the carriage, particularly illustrating the construction of the articulated caster depicted in FIG. 2;

FIG. 4 is a fragmentary side view in partial vertical section of the carriage, particularly showing the articulated caster depicted in FIGS. 2 and 3;

FIG. 5 is a fragmentary side view of the carriage, specifically showing the articulated caster as the carriage travels on a sloped surface;

FIG. 6 is a front view of the carriage and illustrating the articulated caster as the carriage traverses a side-sloped surface;

FIG. 7 is a fragmentary side view of the carriage, particularly showing the articulated caster as the carriage travels over an uneven surface; and

FIG. 8 is a perspective view of an articulated caster constructed in accordance with another preferred embodiment of the present invention.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

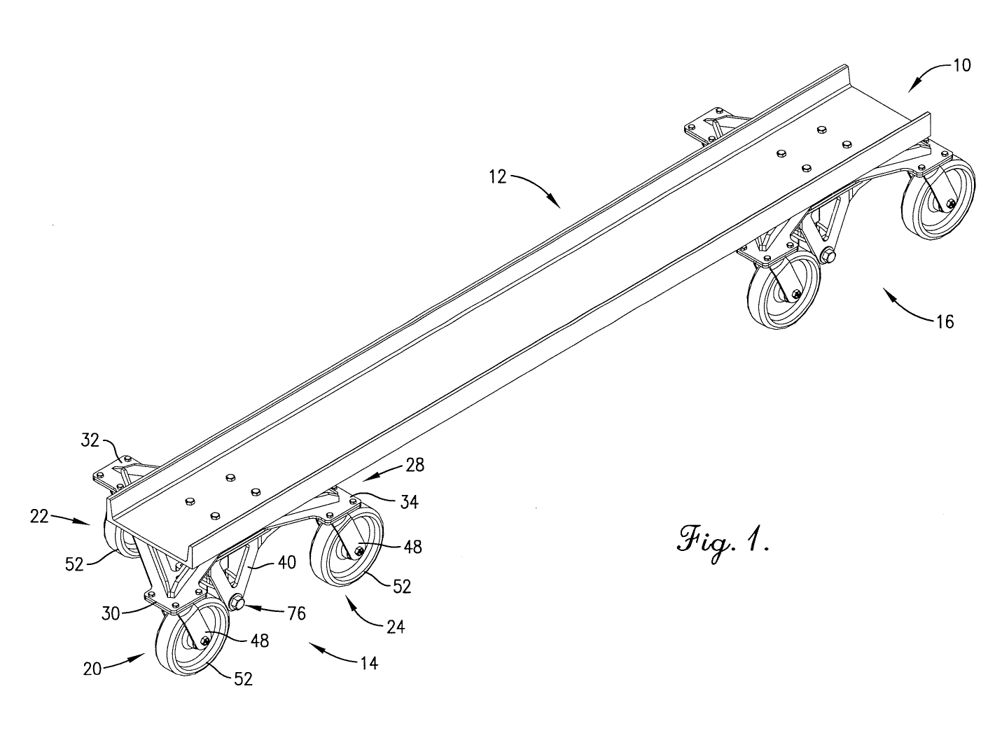

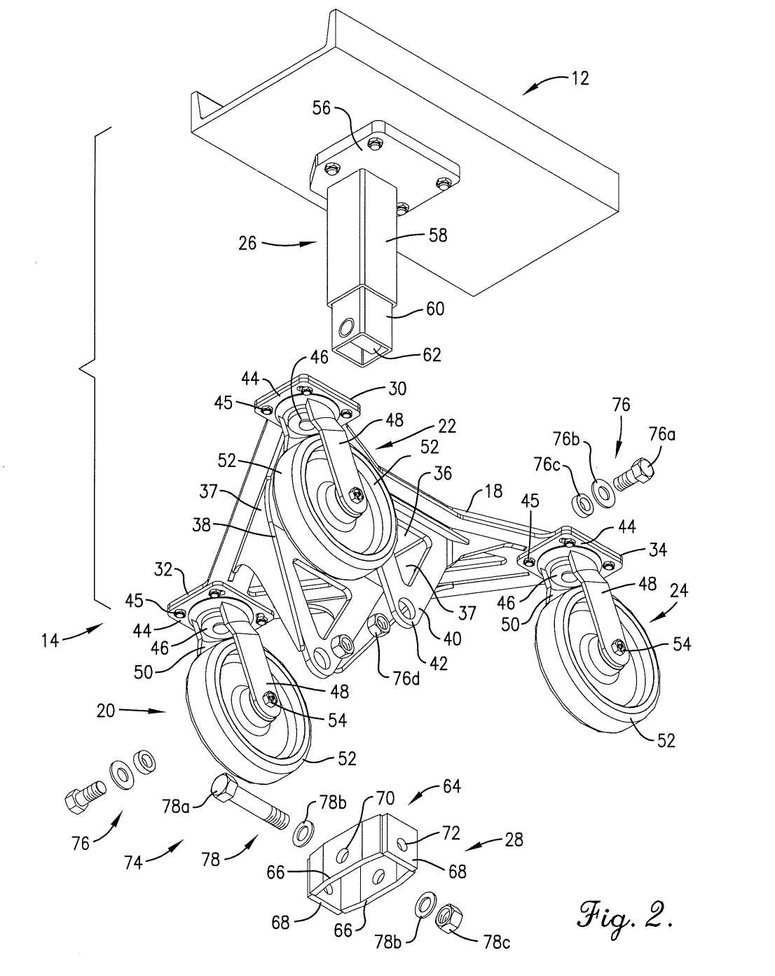

Turning now to the drawings, a wheeled carriage 10 is depicted in FIG. 1 and generally includes an elongated, somewhat tray-shaped load-bearing component 12 and a pair of fore and aft articulated casters 14 and 16. The casters 14, 16 are identical, and therefore only caster 14 will be described in detail. Broadly speaking, the caster 14 (see. FIG. 2) includes a base 18 supported by a total of three caster wheels 20, 22, and 24, an upright pivot arm 26, and a pivot assembly 28 serving to interconnect the pivot arm 26 and base 20 to provide an articulated connection therebetween.

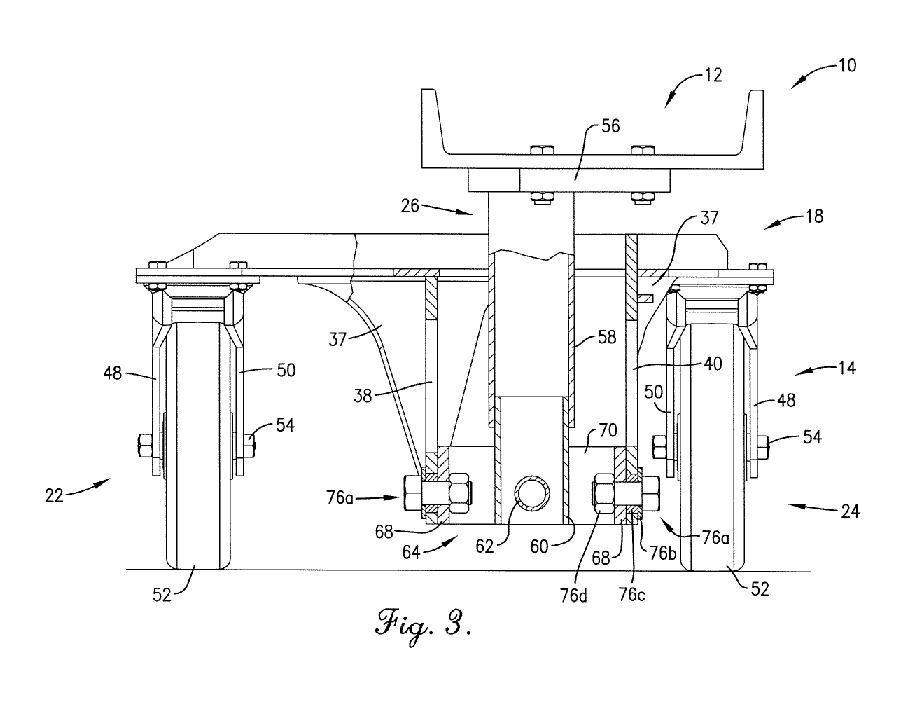

In more detail, the base 18 is somewhat triangular in shape and presents three wheel-mounting apices 30, 32, and 34. The base 18 has a generally central opening 36 and depending strengthening webs 37. A pair of opposed depending triangular support legs 38 and 40 extend downwardly from the underside of base 18 and have aligned apertures 42. As best illustrated in FIG. 3, the base 18 is designed such that the wheels 20 and 24 are beneath component 12, whereas wheel 22 is situated outboard of this component.

The caster wheels 20-24 are identical and each includes a mount 44 configured to mate with a corresponding base apex 30, 32, or 34, with fasteners 45 interconnecting the base apices and mounts. A swivel coupler 46 is secured to the underside of each mount 44 and a pair of opposed support arms 48 and 50 depend from the swivel coupler 46. A wheel 52 is secured between the arms 48 and 50 via fastener 54. It will thus be appreciated that the wheels 20-24 are independently pivotal about respective, upright pivot axes.

The base 18 and wheels 20-24 cooperatively form a caster assembly that is self-supporting and particularly effective in supporting, along with other similarly constructed caster assemblies, extraordinarily large loads. The illustrated caster assembly is similar to that disclosed and claimed in U.S. patent application Ser. No. 10/886,369, entitled ARTICULATED CASTER, filed Jul. 6, 2004; and U.S. patent application Ser. No. 11/277,538, entitled ARTICULATED CASTER, filed contemporaneously herewith; both of which are assigned of record to the assignee of the present application and are hereby incorporated by reference herein. However, those ordinarily skilled in the art will appreciate that certain principles of the present invention are applicable to other caster assembly designs. For example, although the illustrated design is most preferred, the caster assembly may be provided with more caster wheels than illustrated, the base can have alternative shapes, etc.

The illustrated pivot arm 26 is a rigid metallic part having an upper connection flange 56 and a depending arm member 58. The member 58 is of square tubular configuration and terminates in a lowermost tubular section 60 of reduced cross-sectional area, which is interfitted within the member 58. The section 60 carries a transversely extending bushing 62 forming a through passageway. Other suitable pivot arm designs are entirely within the ambit of the present invention, as will be subsequently described.

The illustrated pivot assembly 28 differs significantly from that disclosed in the incorporated applications. More specifically, the pivot assembly 28 includes an open-top housing 64 of generally quadrate plan configuration, presenting opposed sidewalls 66 and opposed end walls 68. As best seen in FIG. 2, the sidewalls 66 have aligned apertures 70, and likewise the end walls have aligned apertures 72. The overall pivot assembly 28 further includes a connection assembly 74 serving to secure the housing 64, base 18, and pivot arm 26 in order to permit relative pivoting movement between the pivot arm 26 and base 18 about generally horizontal and transverse pivot axes.

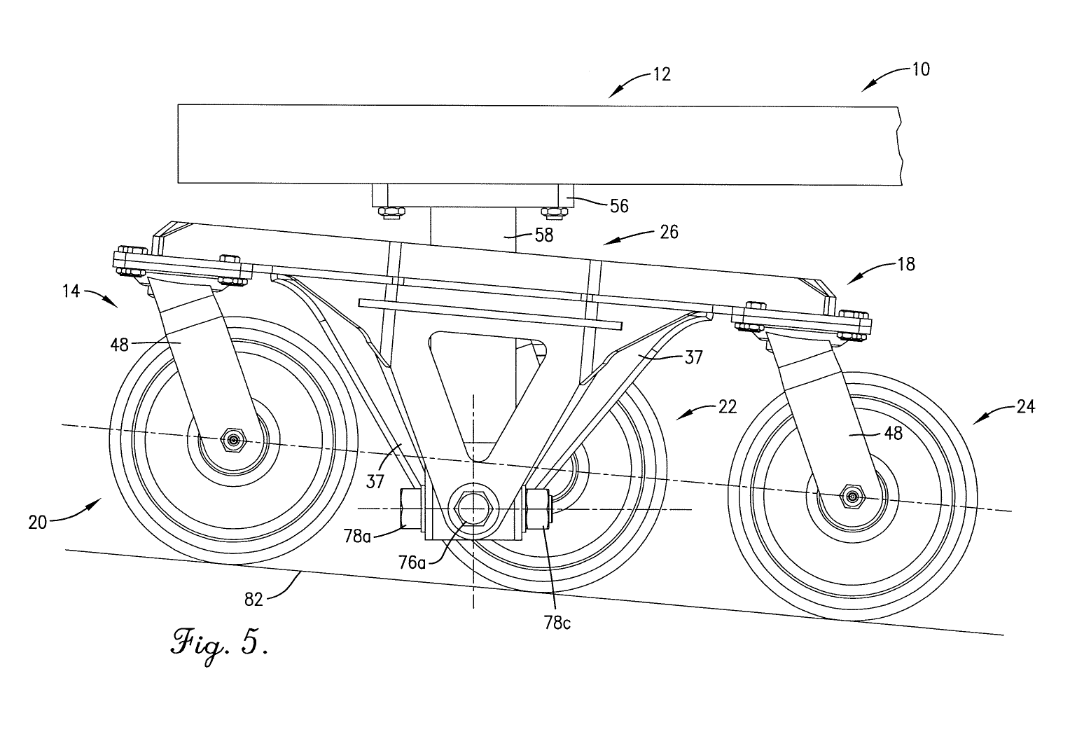

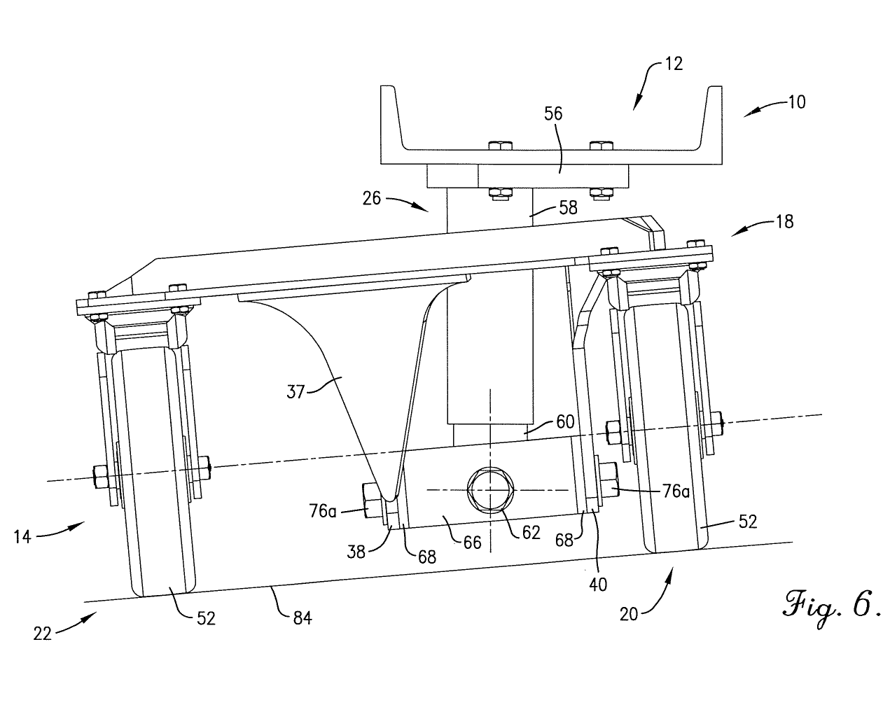

The housing 64 is located between the lower ends of the support legs 38 and 40 with the apertures 42 thereof in alignment with the end wall apertures 72 of the housing. A pair of short bolt and nut assemblies 76 (bolt 76a, washer 76b, bushings 76c, and nut 76d) are used to secure the housing 64 to the legs 38 and 40, and to permit the housing to rotate about a pivot axis defined by the bolts 76a. Again referring to FIG. 2, it will be seen that the lowermost tubular section 60 of arm 58 is received within the confines of housing 64, with the bushing 62 in alignment with sidewall apertures 70. A longer bolt and nut assembly 78 (bolt 78a, washers 78b, and nut 78c) extends through the sidewall apertures 70 and 62 in order to secure the housing 64 to pivot arm 26 and to allow the pivot arm to rotate about an axis defined by the bolt 78a. It will be noted in this regard that the pivot axes defined by the assemblies 76 and 78 are substantially coplanar and orthogonal; these axes are also below the upper surface of base 18. However, the principles of the present invention are equally applicable to axes that do not intersect (e.g., are vertically offset) and/or are not perpendicular relative to one another. Moreover, as perhaps best depicted in FIGS. 5 and 6, the axes are preferably spaced below the rotational axes of wheels 20-24 (assuming the surface is level or only slightly inclined). In other words, the pivot axes provided by the assembly 28 are preferably closer to the surface than the wheel axes. As noted in the incorporated applications, this arrangement provides tremendous stability to the carriage 10.

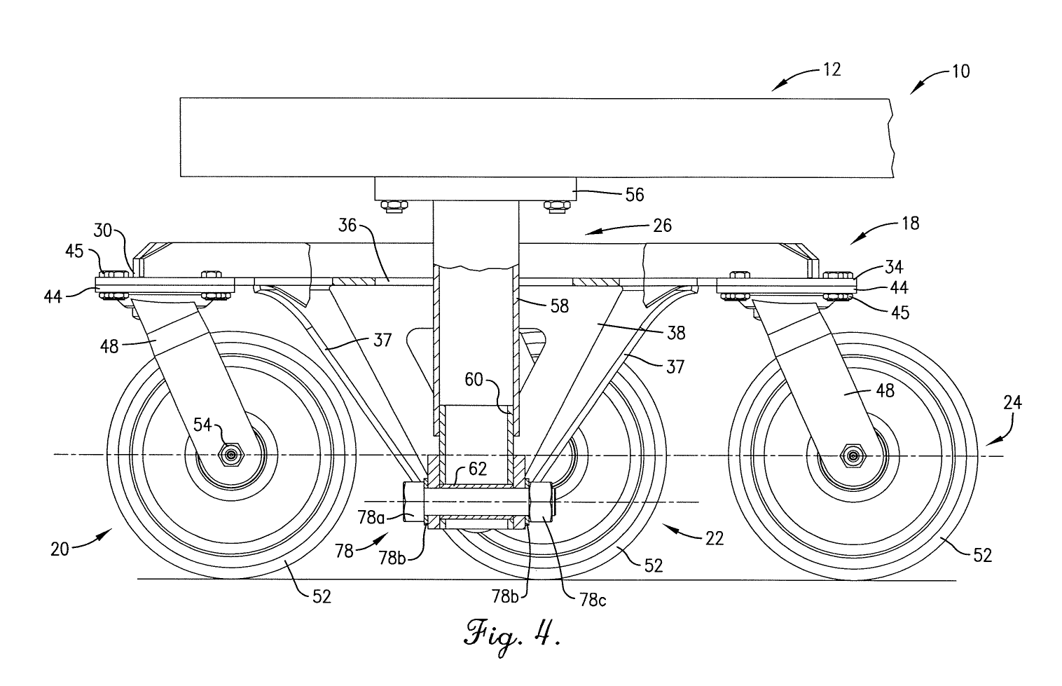

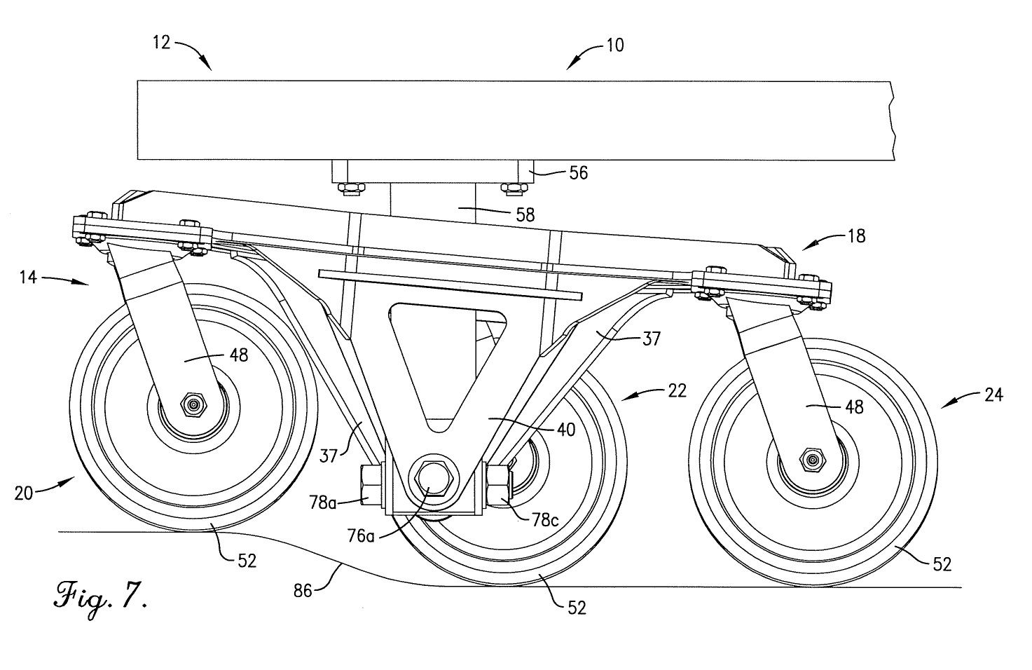

FIG. 4 illustrates the carriage 10 during movement thereof along a substantially even and flat surface 80. In such a situation, three casters 20, 22, and 24 are aligned and there is essentially no relative pivoting between arm 26 (and hence load-bearing component 12) and base 18. When the carriage 12 encounters an inclined surface 82 (FIG. 5), the pivot assembly 28 comes into play to maintain the component 12 in the desired orientation (e.g., a substantially horizontal orientation) through articulation of the caster assemblies 14 and 16. In detail, the base 18 pivots about the axis defined by bolts 76a to accommodate the sloped surface. Likewise, when the carriage 10 encounters a side sloped surface 84 (FIG. 6), the base 18 pivots about the axis defined by bolt 78a to again maintain the component 12 in a substantially horizontal orientation. The base 18 may simultaneously pivot about both of the horizontal axes when an obstruction is encountered or an uneven surface 86 is traversed. In this case, the base 18 will pivot about both of the axes respectively defined by the bolts 76a and bolt 78a (FIG. 7).

The articulated casters of the present invention, making use of the open-top housing 64 secured to base 18 and to the lower end of pivot arm 26, provide a number of advantages as compared with prior art caster designs. For example, use of the pivot housing requires the pivot arm 26 to be only of simple square configuration versus prior art forked designs requiring multiple cutting, machining, welding, and/or casting operations to fabricate. Indeed, the housing 64 can readily be fabricated using a single laser cutting operation providing the rectangular configuration and the mounting apertures. Prior pivot block designs require at least four machining operations to give sizing and drilling of the center and end mounting apertures. Such pivot block units also require threading of the end holes. This is eliminated in the present invention where the housing apertures are unthreaded. The present pivot arm/pivot assembly is smaller and has a higher strength:weight ratio. Moreover, if it is desired to increase the strength of the pivot assembly, housing 64 can easily be increased in height without affecting the remainder of the caster assembly.

Because of the use of the articulated casters 14 and 16, the carriage is particularly effective in supporting large loads for traversal on uneven or inclined surfaces or across obstacles (such as debris on the surface). If desired, the carriage can be provided with more or less casters than depicted. Furthermore, each pivot arm can be associated with a gang of casters if desired. Another suitable but alternative carriage design is depicted in U.S. patent application Ser. No. 11/277,546, entitled QUAD-CASTER CARRIAGE WITH FORKLIFT ATTACHMENT, filed contemporaneously herewith, assigned of record to the assignee of the present application, and hereby incorporated by reference herein.

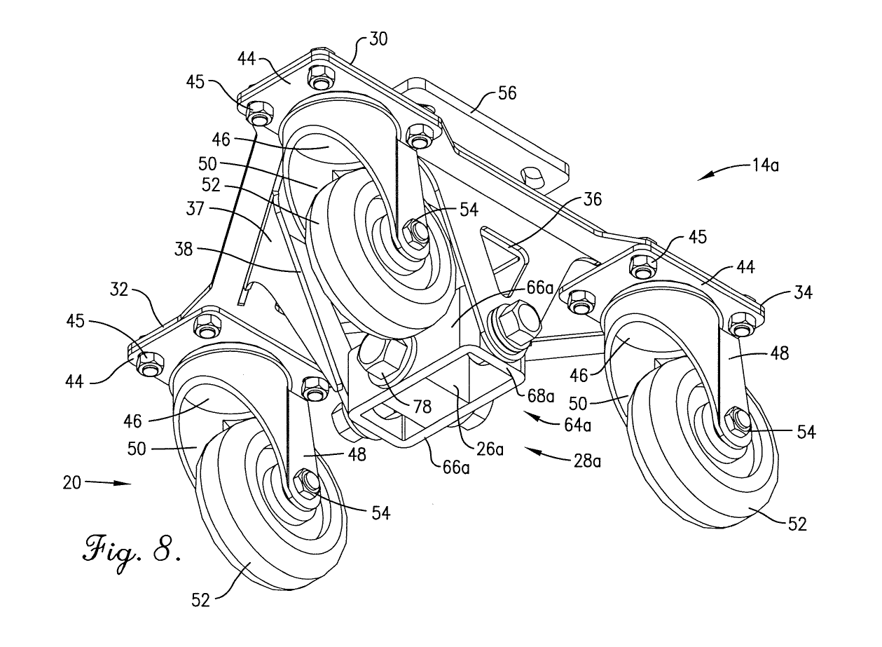

The principles of the present invention are equally applicable to other pivot assembly designs. For example, FIG. 8 illustrates another caster 14a constructed in accordance with another preferred embodiment of the present invention. The caster 14a is in many respects identical with previously described caster14, and accordingly like components will be numbered as set forth above. However, the caster 14a differs in the construction of the pivot assembly 28a. In this instance, the assembly 28a includes a depending pivot arm 26a which is formed of solid block metal and having a through-aperture for receiving the screw and nut assembly 78. Also, in this embodiment, the housing 64 is replaced by a solid extruded metallic tubing 64a of rectangular shape and having apertured end walls 68a and apertured sidewalls 66a. It will be appreciated that this pivot assembly is less expensive than the design depicted in FIG. 2, inasmuch as the arm 26a can be fabricated from inexpensive bar stock, while the housing 64a can be easily cut from a length of conventional tubing stock.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. An articulated caster comprising:
a caster assembly including a base and at least three spaced apart caster wheels that are attached to and cooperatively support the base so that the caster assembly is self-supporting;
an upright pivot arm having a lower end and an upper end adapted for connection with a load; and
a pivot assembly operably coupling the lower end of the arm with the base,
said pivot assembly including an open-top housing receiving the lower end of the pivot arm,
said pivot assembly further including a connection assembly interconnecting the housing, base, and pivot arm in order to permit relative pivotal movement between the pivot arm and base about generally transverse first and second pivot axes.

2. The articulated caster as claimed in claim 1,
said caster wheels being arranged in a generally triangular fashion.

3. The articulated caster as claimed in claim 1,
said housing being substantially quadrate in plan configuration and presenting opposed sidewalls and opposed end walls.

4. The articulated caster as claimed in claim 3,
said connection assembly comprising a pair of connectors interconnecting the base and the housing end walls and defining the first pivot axis,
said connection assembly further including a second connector interconnecting the pivot arm and the housing sidewalls and defining the second pivot axis transverse.

5. The articulated caster as claimed in claim 4,
said first pair of connectors comprising a pair of bolt and nut assemblies.

6. The articulated caster as claimed in claim 4,
said second connector comprising an elongated bolt and nut assembly passing through the sidewalls and the lower end of the pivot arm.

7. The articulated caster as claimed in claim 6,
said lower end of the pivot arm having an elongated bushing receiving the elongated bolt.

8. The articulated caster as claimed in claim 1,
said first and second pivot axes intersecting to lie on a common plane.

9. The articulated caster as claimed in claim 8,
said common plane cooperatively defined by the pivot axes being substantially horizontal.

10. The articulated caster as claimed in claim 1,
said housing having an open bottom.

11. The articulated caster as claimed in claim 1,
said base having a central opening for receiving the pivot arm and sized to permit significant relative pivoting movement between the base and pivot arm.

12. A carriage comprising:
an elongated load-supporting component; and
at least a pair of spaced apart wheeled assemblies supporting the component, at least one of said assemblies comprising an articulated caster, said articulated caster including
a caster assembly including a base and at least three spaced apart caster wheels that are attached to and cooperatively support the base so that the caster assembly is self-supporting,
an upright pivot arm having a lower end and an upper end connected to the load-supporting component, and
a pivot assembly operably coupling the lower end of the arm with the base,
said pivot assembly including an open-top housing receiving the lower end of the pivot arm,
said pivot assembly further including a connection assembly interconnecting the housing, base, and pivot arm in order to permit relative pivotal movement between the pivot arm and base about generally transverse first and second pivot axes.

13. The carriage as claimed in claim 12,
each of said wheeled assemblies comprising said articulated caster.

14. The carriage as claimed in claim 12,
said component comprising an elongated panel having upright sidewalls.

15. The carriage as claimed in claim 12,
said caster wheels being arranged in a generally triangular fashion.

16. The carriage as claimed in claim 12,
said housing being substantially quadrate in plan configuration and presenting opposed sidewalls and opposed end walls.

17. The carriage as claimed in claim 16,
said connection assembly comprising a pair of connectors interconnecting the base and the housing end walls and defining the first pivot axis,
said connection assembly further including a second connector interconnecting the pivot arm and the housing sidewalls and defining the second pivot axis transverse.

18. The carriage as claimed in claim 17,
said first pair of connectors comprising a pair of bolt and nut assemblies.

19. The carriage as claimed in claim 17,
said second connector comprising an elongated bolt and nut assembly passing through the sidewalls and the lower end of the pivot arm.

20. The carriage as claimed in claim 19,
said lower end of the pivot arm having an elongated bushing receiving the elongated bolt.

21. The carriage as claimed in claim 12,
said first and second pivot axes intersecting to lie on a common plane.

22. The carriage as claimed in claim 21,
said common plane cooperatively defined by the pivot axes being substantially horizontal.

23. The carriage as claimed in claim 12,
said housing having an open bottom.

24. The carriage as claimed in claim 12,
said base having a central opening for receiving the pivot arm and sized to permit significant relative pivoting movement between the base and pivot arm.
